(19) United States
(12) Patent Application Publication
(10) Pub. No.: US 2003/0212748 A1
(43) Pub. Date: Nov. 13, 2003

(54) Mail-incoming rejection system, mail-incoming rejection method, and mail-incoming rejection program

(76) Inventor: Yasuo Nakata, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/429,869

(22) Filed: May 6, 2003

(30) Foreign Application Priority Data
May 8, 2002 (JP) JP2002-133217

(51) Int. Cl. G06F 15/16

(52) U.S. Cl. 709/206; 709/203

(57) ABSTRACT

In a mail delivery system 10, a mail-incoming rejection system is configured so that: transmission destination mail address information 130 of electronic mail 120 includes transmission destination mail addresses 131a to 13na, and destination names 131b to 13nb including a keyword 125 specific to the transmission destination mail address; and with regard to the electronic mail 120 received in a mail delivery center 300, which corresponds to the transmission destination mail address, via a network 500, its receiving section 320 collates the keyword from the destination name to be included in the transmission destination mail address information, and delivers only the electronic mail, for which the collation of the keyword was able to be made, to the above transmission destination mail address.

### BACKGROUND OF THE INVENTION

The present invention relates to a mail delivery service utilizing a network such as an Internet, a general public circuit etc., and more particular to technology for realizing the incoming rejection.

In recent years, the electronic mail utilizing the network has prevailed explosively; however a conventional mail delivery system is configured so that, when a user transmits the electronic mail to a mail transmission server from a mail terminal, based on a mail address of a transmission destination to be included in a header section of the above electronic mail, the mail transmission server transmits it to a mail server of the transmission destination.

By the way, so-called junk mail for utilizing convenience of such electronic mail to directly send the electronic mail to a great many of unspecified persons has increased remarkably.

In the event of transmitting such junk mail, by paying attention to the fact that, as a rule, the mail address is generated by combination of alphabets, and numerals/symbols, for example, soft for automatic generation of the mail address is used to generate a great many of the mail addresses.

And, as the case may be, by indiscriminately transmitting the electronic mail to respective mail addresses generated in such a manner, and accumulating as a data base the available mail addresses, from which a reply was received, out of the mail addresses indiscriminately transmitted in such a manner, acquisition of a mail address list is intended.

However, such junk mail is not only substantially-unnecessary mail for the receiving side, but also if a reply is made carelessly, the mail address results in being registered to the data base of the mail address for the junk mail.

Also, when the number of the received junk mail increases, the truly necessary electronic mail is buried among many kinds of the junk mail, and the electronic mail desired for reading becomes difficult to find in some cases.

On the other hand, due to increase in such junk mail, a ratio of the junk mail number to the total mail delivery number remarkably has increased in such a manner that it accounts for more than half, a load of the mail delivery system increases, and the smooth mail delivery results in being prevented, such as the case that delivery delay occurs.

For this end, for example, based on the mail address of the originator to be included in the header section of the electronic mail, with regard to specific mail addresses and domain names, it is actually done in part to reject the incoming of the electronic mail.

However, it is also possible to assume a false originator mail address of the electronic mail, or in the event of frequently altering the mail address to transmit the junk mail, even though such incoming rejection by means of the mail address and the domain name is carried out, it becomes impossible substantially to prevent the junk mail from being received.

### SUMMARY OF THE INVENTION

The present invention has been accomplished so as to settle out the above-mentioned problems, and an objective thereof is to provide a mail-incoming rejection system, a mail-incoming rejection method, and a mail-incoming rejection program that allowed the incoming of the unnecessary electronic mail to be rejected certainly.

So as to accomplish this objective, the mail-incoming rejection system of the present invention is configured so that, in a mail delivery system including a plurality of mail delivery centers connected to each other via a network wherein electronic mail that is composed of transmission destination mail address information and a mail text etc. from a user's mail terminal is transmitted from the mail delivery center on the transmitting side to the mail delivery center on the receiving side, which corresponds to the transmission destination mail address, via the network, the above-mentioned transmission destination mail address information of the electronic mail has a transmission destination mail address, and a destination name, said destination name having a keyword specific to the transmission destination mail address included in its destination name, and each mail delivery center is provided with: a transmitting section for transmitting the electronic mail received from each user's mail terminal to the other mail delivery center, which corresponds to the transmission destination mail address, via the network, or transmitting it to a receiving section of the above mail delivery center; and the receiving section for, with regard to the electronic mail received from the other mail delivery center via the network, or transmitted from the transmitting section, collating the keyword from the destination name to be included in the transmission destination mail address information to deliver only the electronic mail, for which collation of the keyword was able to be made, to the above transmission destination mail address, and not to deliver the electronic mail for which the collation of the keyword is not able to be made.

The mail-incoming rejection system having such a configuration allows the user who receives the mail to pre-register the keyword to the mail delivery center to which he/she belongs, and to inform the mail originator thereof. And, in the event of transmitting the electronic mail to the above user, the mail originator inputs the above keyword into the destination name of the transmission destination mail address information of the electronic mail.

Thereby, the electronic mail transmitted to the above user from the mail originator is transmitted from the transmitting section of the mail delivery center on the transmitting side to the mail delivery center on the receiving side, which corresponded to the transmission destination mail address of the transmission destination mail address information, via the network, and is received in the receiving section of the mail delivery center on the receiving side.

And, the received electronic mail is keyword-collated from the destination name of its transmission destination mail address information in the receiving section of the mail delivery center on the receiving side, and only the electronic mail for which the collation of the keyword was able to be made is transmitted to the above transmission destination mail address. To the contrary, the incoming of the electronic mail for which the collation of the keyword was not able to made is rejected, and the above electronic mail is not transmitted.

Accordingly, the user pre-informs of the keyword the partners having the possibility of transmitting the mail, and thereby can receive only the normal electronic mail having the keyword input into the destination name, and reject the incoming of the unnecessary electronic mail such as the junk mail.

The mail-incoming rejection system is configured so that the receiving section of each mail delivery center comprises a storage section for, with regard to the mail address of the user that belongs hereto, registering the data base that is composed of the pre-established keywords.

The mail-incoming rejection system having such a configuration allows the receiving section to quickly make the collation of the keyword, in collating the keyword from the destination name of the transmission destination mail address information of the electronic mail, by reading out the keyword specific to the transmission destination mail address of the above electronic mail from the storage section to make reference hereto.

The mail-incoming rejection system is configured so that, when the above-mentioned receiving section was not able to make the collation of the keyword, it cancels the above electronic mail.

The mail-incoming rejection system having such a configuration allows accumulation of the unnecessary electronic mail to be prevented, and the load of the mail delivery center to be alleviated, by canceling the electronic mail of which the incoming was rejected.

The mail-incoming rejection system 4 is configured so that, when the above-mentioned receiving section was not able to make the collation of the keyword, with regard to the above electronic mail, it replies an error for the mail delivery center on the transmitting side.

The mail-incoming rejection system having such a configuration allows the effect of the mail-incoming rejection to be told, by replying the error for the mail delivery center on the transmitting side with regard to the electronic mail of which the incoming was rejected.

The mail-incoming rejection system is configured so that the above-mentioned transmission destination mail address information has a plurality of transmission destination addresses and destination names, and the above-mentioned keyword is included in any one of the destination names.

The mail-incoming rejection system having such a configuration allows the keyword to be input easily without inputting the keyword into the destination name transmission destination mail address by transmission destination mail address by, in the event of the electronic mail addressed to a plurality of the transmission destination mail addresses, inputting the keyword into any one of the destination names for a plurality of the transmission destination mail addresses having the common keyword established.

Also, so as to accomplish the above-mentioned objective, the mail-incoming rejection method of the present invention is configured so that, in a mail delivery system including a plurality of mail delivery centers connected to each other via a network wherein electronic mail that is composed of transmission destination mail address information and a mail text etc. from a user's mail terminal is transmitted from the mail delivery center on the transmitting side to the mail delivery center on the receiving side, which corresponds to the transmission destination mail address, via the network, are included: a first step of, at the time of preparing the electronic mail, with regard to transmission destination mail address information that is composed of a transmission destination mail address, and a destination name, inputting a keyword specific to the transmission destination mail address into its destination name; a second step of collating the keyword from the destination name to be included in the transmission destination mail address information in the mail delivery center on the receiving side that received delivery of the above electronic mail; and a third step of delivering only the electronic mail, for which the collation of the keyword was able to be made, to the above transmission destination mail address, and not delivering the electronic mail for which the collation of the keyword is not able to be made.

The mail-incoming rejection method having such a configuration allows the user who receives the mail to pre-register the keyword to the mail delivery center to which he/she belongs, and to inform the mail originator thereof. And, in the event of transmitting the electronic mail to the above user, the mail originator inputs the above keyword into the destination name of the transmission destination mail address information of the electronic mail in the first step.

Thereby, the electronic mail transmitted to the above user from the mail originator is transmitted from the mail delivery center on the transmitting side to the mail delivery center on the receiving side, which corresponded to the transmission destination mail address of the transmission destination mail address information, via the network, and is received in the mail delivery center on the receiving side.

And, the received electronic mail is keyword-collated from the destination name of its transmission destination mail address information in the second step, and only the electronic mail for which the collation of the keyword was able to be made is transmitted to the above transmission destination mail address in the third step. To the contrary, the incoming of the electronic mail for which the collation of the keyword was not able to be made is rejected, and the above electronic mail is not transmitted.

Accordingly, the user pre-informs of the keyword the partners having the possibility of transmitting the mail, and thereby, he/she can receive only the normal electronic mail having the keyword input into the destination name, and reject the incoming of the unnecessary electronic mail such as the junk mail.

The mail-incoming rejection method is configured so that, in the above-mentioned third step, with regard to the mail address of the user that belongs, reference is made to a data base that is composed of pre-established keywords to make the collation of the keyword.

The mail-incoming rejection method having such a configuration allows the collation of the keyword to be made quickly by, in the third step, in collating the keyword from the destination name of the transmission destination mail address information of the electronic mail, reading out the keyword specific to the transmission destination mail address of the above electronic mail from the storage section for making reference hereto.

The mail-incoming rejection method is configured so that, in the above-mentioned third step, when the collation of the keyword was not able to be made, the above electronic mail is cancelled.

The mail-incoming rejection method having such a configuration allows accumulation of the unnecessary electronic mail to be prevented, and the load of the mail delivery center to be alleviated, by canceling the electronic mail of which the incoming was rejected in the third step.

The mail-incoming rejection method is configured so that, in the above-mentioned third step, when the collation of the keyword was not able to be made, with regard to the above electronic mail, an error is replied for the mail delivery center on the transmitting side.

The mail-incoming rejection method having such a configuration allows the effect of the mail-incoming rejection to be told by, with regard to the electronic mail of which the receive was rejected in the third step, replying the error to the mail delivery center on the transmitting side.

The mail-incoming rejection method is configured so that, in the above-mentioned first step, with regard to the transmission destination mail address information having a plurality of the transmission destination mail addresses and the destination names, the keyword is input into any one of the destination names.

The mail-incoming rejection method having such a configuration allows the keyword to be input easily without inputting the keyword into the destination name transmission destination mail address by transmission destination mail address by, in the event of the electronic mail addressed to a plurality of the transmission destination mail addresses, inputting the keyword into any one of the destination names for a plurality of the transmission destination mail addresses having the common keyword established in the first step.

Furthermore, so as to accomplish the above-mentioned objective, the mail-incoming rejection program, which is a mail-incoming rejection program for causing a computer to execute a process of receiving the electronic mail transmitted from a user's mail terminal via the network, which is composed of transmission destination mail address information and a mail text etc., in the mail delivery center on the receiving side that corresponds to the transmission destination mail address, and delivering only the normal electronic mail to the transmission destination mail address, is configured so that: the electronic mail addressed to the mail address of the user that belongs is received; the keyword is collated from the destination name to be included in the transmission destination mail address information of the above electronic mail; only the normal electronic mail for which the collation of the keyword was able to be made is delivered to the above transmission destination mail address; and the unjust electronic mail for which the collation of the keyword is not able to be made is not delivered.

In such a manner, the present invention can be embodied as the mail-incoming rejection program as well.

Furthermore, so as to accomplish the above-mentioned objective, a computer for executing a process of receiving electronic mail, which is composed of transmission destination mail address information and a mail text etc. from a user's mail terminal, in a mail delivery center on a receiving side that corresponds to a transmission destination mail address, and delivering only the normal electronic mail to the transmission destination mail address, said computer executing a process of: receiving the electronic mail addressed to a mail address of a user that belongs; collating a keyword based on a destination name to be included in the transmission destination mail address information of said electronic mail; and delivering the normal electronic mail for which collation of the keyword was able to be made to said transmission destination mail address and un-delivering the unjust electronic mail for which the collation of the keyword is not able to made.

In such a manner, in accordance with the present invention, utilization of the destination name, which is not able to be grasped in the event of automatically generating the mail address in the junk mail etc. and the like, as the keyword allows the incoming of the unnecessary electronic mail such as the junk mail to be certainly rejected, by making the keyword collation of the destination name.

This allows the load of the mail delivery center to be alleviated because the receiving side can escape receiving the unnecessary electronic mail such as the junk mail, and the transmitting side can suppress origination of a large volume of the junk mail.

### BRIEF DESCRIPTION OF THE DRAWINGS

This and other objects, features and advantages of the present invention will become more apparent upon a reading of the following detailed description and drawings, in which:

FIG. 1 is a block diagram illustrating a configuration of the essential part of a mail-incoming rejection system of one embodiment of the present invention,

FIG. 2 is a schematic view illustrating the entire configuration of the mail-incoming rejection system of FIG. 1,

FIG. 3 is a view illustrating one example of transmission destination mail address information of electronic mail in the mail-incoming rejection system of FIG. 1,

FIG. 4 is a view illustrating one example of a data base of a keyword to be registered in a storage section in the mail-incoming rejection system of FIG. 1,

FIG. 5 is a flowchart illustrating a mail information transmission work in the mail-incoming rejection system of FIG. 1 and

FIG. 6 is a flowchart illustrating a mail information reception/delivery work in the mail-incoming rejection system of FIG. 1.

### DESCRIPTION OF THE EMBODIMENTS

Hereinafter, an embodiment of the present invention will be explained by referring to the accompanied drawings.

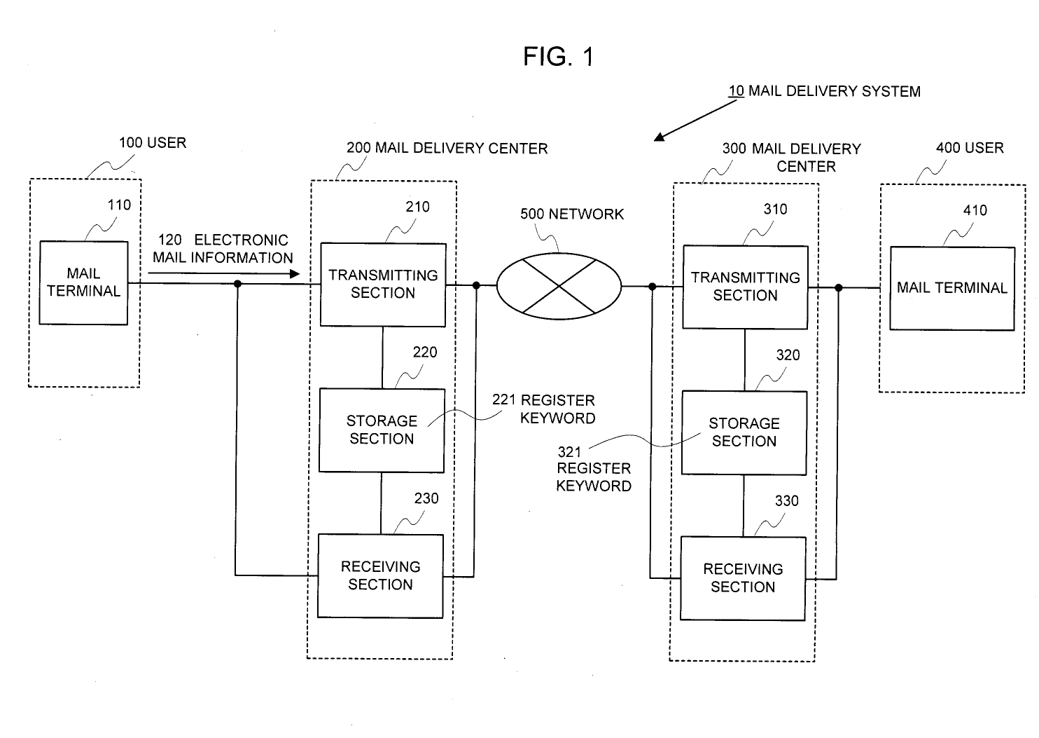

One embodiment of the mail delivery system including the mail-incoming rejection system of the present invention will be explained by referring to the FIG. 1 to FIG. 6.

FIG. 1 is a block diagram illustrating a configuration of the mail delivery system of this embodiment.

As shown in FIG. 1, a mail delivery system 10 is provided with a user 100 on a transmitting side, a mail delivery center 200 on a transmitting side, a mail delivery center 300 on a receiving side, a user 400 on a receiving side, and a network 500.

Additionally, as to the user 100 and the user 400, only each one user is illustrated in FIG. 1; however they are not limited to each one user, and furthermore, it is possible for the user 100 to become the user 400, and vice versa, responding to transmission/reception of the electronic mail.

Also, as to the mail delivery center 200 on the transmitting side and mail delivery center 300 on the receiving side, only one center is illustrated in FIG. 1 respectively; however they are not limited to each one center, furthermore, it is possible for each of them to become either one on the receiving side or one on the transmitting side, responding to transmission/reception of the electronic mail, and both has an identical configuration.

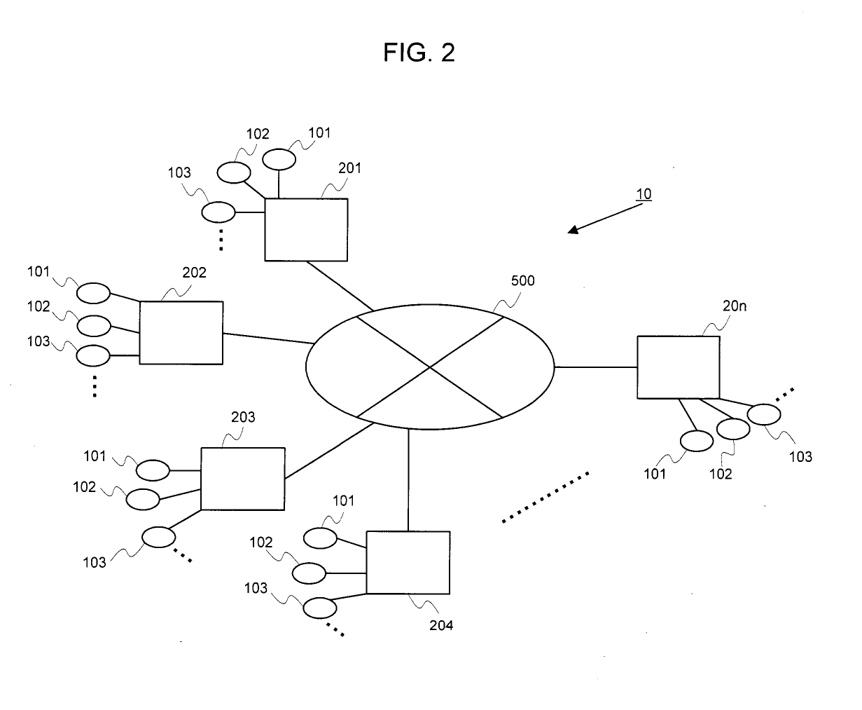

Accordingly, as a matter of fact, the mail delivery system 10 has n mail delivery centers 201, 202, . . . , 20n connected to the network 500, as shown in FIG. 2, and a plurality of users 101, 102, result in being connected to each of the mail delivery centers respectively.

Furthermore, the network 500 is a network such as an ISP (Internet Service Provider) telecommunication network for providing an Internet connection service such as an Internet, a general public circuit network, or a leased line network etc.

It is possible that each of the user 100 and the user 400 becomes the other, responding to either transmission or reception of the electronic mail, and both have an identical configuration, whereby the user 100 will be explained below.

The user 100 who is to receive a mail delivery service can connect to the mail delivery center 200, make access to a transmitting section or a receiving section (to be described later) mounted within the mail delivery center 200, and transmit or receive the electronic mail.

Additionally, the configuration is made so that the user 100 can use a mail terminal 110 as a terminal appliance for making access to the mail delivery center 200, and the other various information terminal appliances and private terminal appliances, and prepare/transmit or receive electronic mail information 120 as the electronic mail, responding to the display of the mail soft to be displayed on a screen of this mail terminal 110.

Herein, the electronic mail information 120 is configured of transmission destination mail address information 130 to be included in the header section, and a mail text etc. (not shown in the figure).

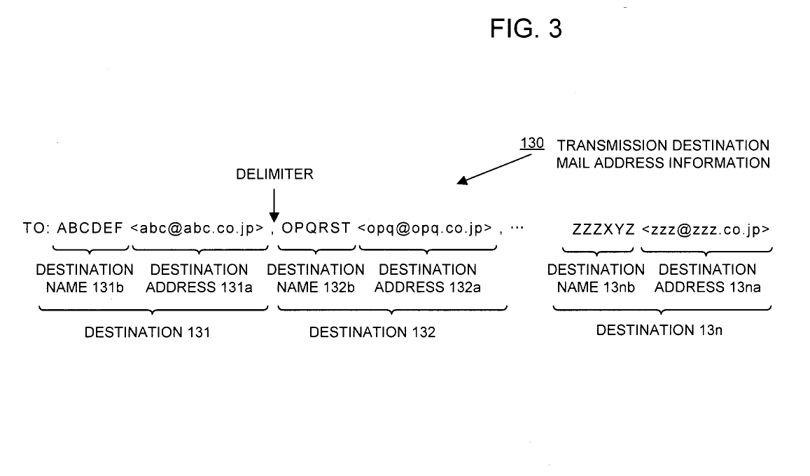

This transmission destination mail address information 130 includes at least one pair (in the event of the illustration in the figure, n pairs) of destinations 131, 132, . . . , 13n, as shown in FIG. 3, and each of the destinations 131, 132, . . . , 13n is arranged in one row with a delimiter ┌,┘ interposed, and includes transmission destination mail addresses 131a, 132a, . . . , 13na, and destination names 131b, 132b, . . . , 13nb respectively.

And, the configuration is made so that a pre-established keyword 125 specific to the transmission destination mail address is included in any one of these destination names 131b, 132b, . . . , 13nb.

Additionally, the destinations 131, 132, . . . , 13n of a so-called ┌To┘ field out of the transmission destination mail address information 130 were explained in FIG. 3; however the above-mentioned keyword 125 is not necessarily included therein, but it may be included in the destinations (not shown in the figure) of a so-called ┌Cc┘ field or ┌Bcc┘ field.

Furthermore, so as to make access to the mail delivery center 200, the user 100 who pre-registered user information (a name, an address etc.), has a mail address and a password by which the above user 100 can be specified straightforwardly.

This allows the mail delivery center 200 to permit access to the transmitting section or the receiving section, by the user 100's transmitting the mail address and the password at the moment of making the connection to the mail delivery center 200.

The mail delivery centers 200 and 300, which are a mail server provide for each entrepreneur (hereinafter, referred to as an ISP) that provides the connection service to the foregoing network 500, have an identical configuration as mentioned before, whereby the mail delivery center 200 will be explained below.

The mail delivery center 200, which is configured of the mail server as an information management apparatus provided at an appropriate location, has a transmitting section 210, a storage section 220, and a receiving section 230.

The above-mentioned transmitting section 210 is connected to individual users 100, who belong to the ISP having the above mail delivery center 200 provided, at an ISP access point via the telecommunication circuit etc., and is connected to the network 500 at a connection point.

And, the above-mentioned transmitting section 210 receives the electronic mail information 120 to be transmitted from the mail terminal 110 of the user 100, and transmits it to the mail delivery center 300 on the receiving side, which corresponded to the transmission destination mail address 131, via the network 500.

Additionally, in the event that the transmission destination mail address 131 is the mail address of the user 100 who belongs to the ISP having the above mail delivery center 200 provided, the above-mentioned transmitting section 210 transmits the electronic mail 120 to the receiving section 230 of the mail delivery center 200 that corresponded to the transmission destination mail address 131.

The above-mentioned storage section 220 temporally stores the electronic mail information 120 to be transmitted from the mail terminal 110 of each user 100.

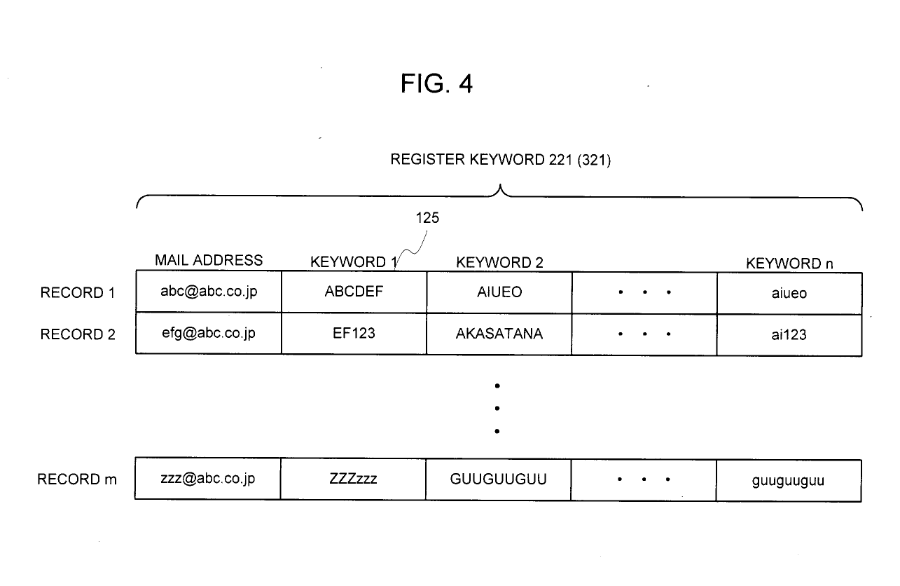

Also, the above-mentioned storage section 220 relates at least one keyword 125, which the user 100 who belongs to the ISP having the above-mentioned mail delivery center 200 provided pre-established, to the mail address for registering it as the data base, as shown in FIG. 4.

Specifically, this data base is configured of, with individual mail addresses taken as records, n keywords related to each mail address for m records, as shown in FIG. 4.

Additionally, at least one keyword 125 should be established for one mail address.

The above-mentioned receiving section 230, which is connected to the network 500 similarly to the transmitting section 210, is connected to individual users 100, who belong to the ISP having the above mail delivery center 200 provided, at the ISP access point via the telecommunication circuit etc., and is connected to the network 500 at the connection point.

Herein, the above-mentioned receiving section 230 receives the electronic mail information 120 to be transmitted from the transmitting section 210, or the other mail delivery center via the network 500, and makes the keyword collation from the destination names 131b, 132b, . . . , 13nb of its transmission destination mail address information 130.

This keyword collation is made, by reading out a register keyword 221 related to the above transmission destination mail address 131 pre-registered in the data base of the storage section 220 to make reference to this register keyword 221, and to sequentially retrieve each of the destination names 131b, 132b, . . . , 13nb.

And, when the collation of the keyword was able to be made, that is, in the event that the register keyword 221 was found in any one of the destination names 131b, 132b, . . . , 13nb, the receiving section 230 delivers the above electronic mail information 120 to the above transmission destination mail address 131.

To the contrary, when the collation of the keyword was not able to made, that is, in the event that no register keyword 221 was found in any one of the destination names 131b, 132b, . . . , 13nb, the receiving section 230 rejects the incoming of the electronic mail information 120, and does not deliver the above electronic mail information 120 to the above transmission destination mail address 131.

And, in the event that the above-mentioned receiving section 230 rejected the incoming of the above electronic mail information 120, it cancels the above electronic mail information 120, and transmits the error saying the effect of the incoming rejection to the mail delivery center on the transmitting side.

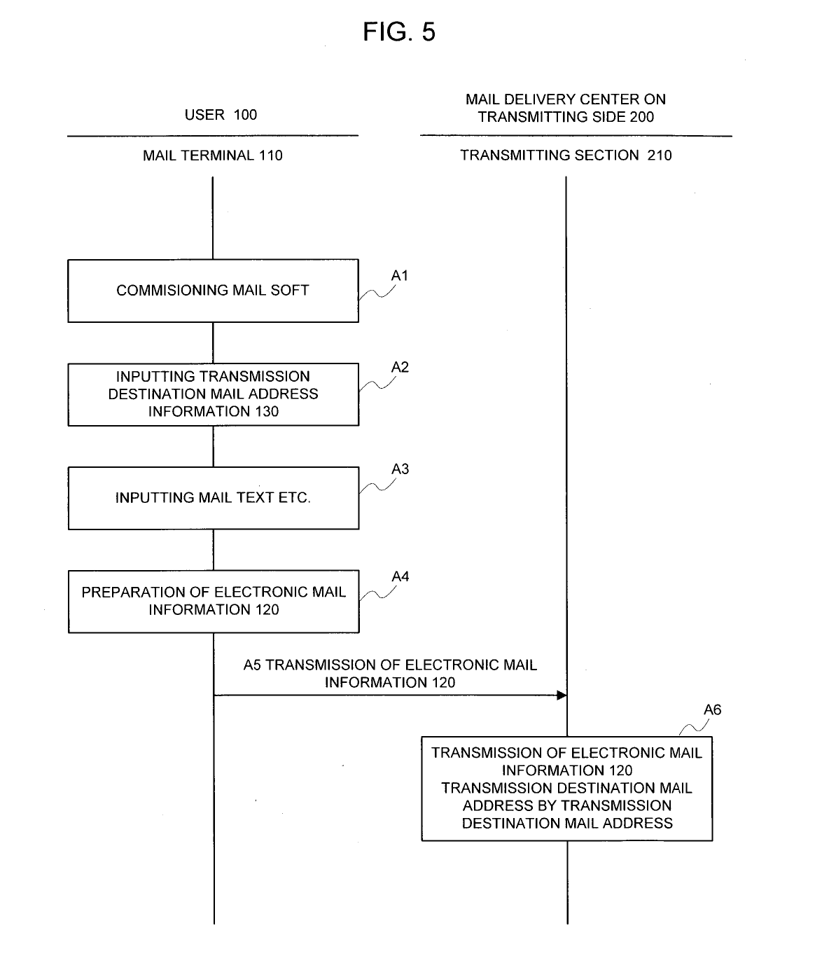

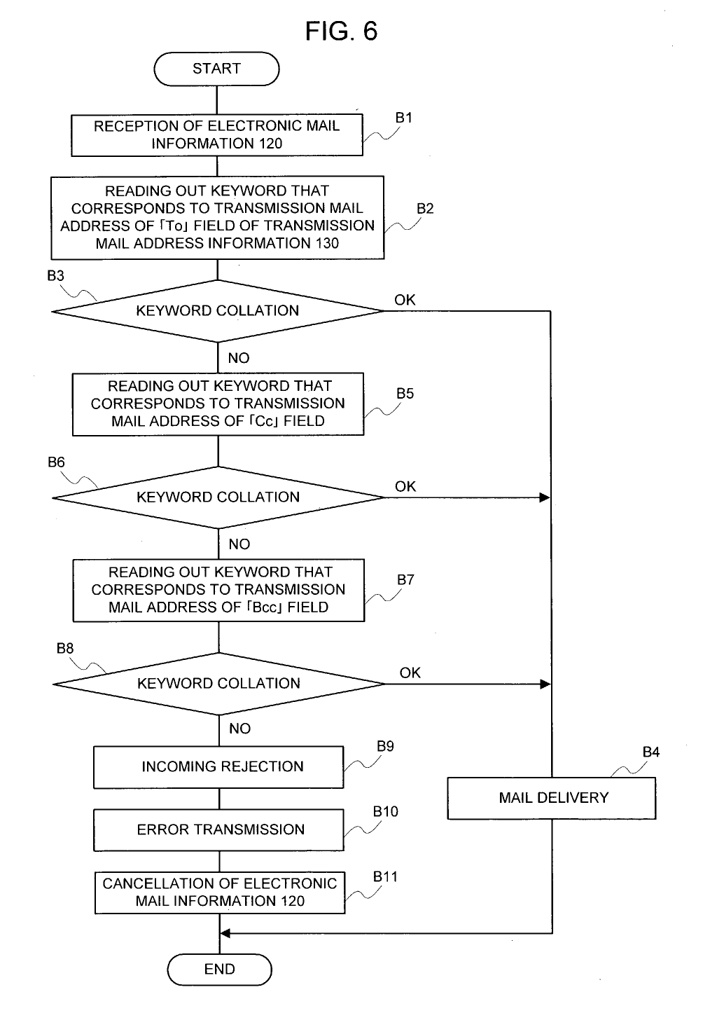

Next, the mail delivery method by the mail-incoming rejection system of this embodiment will be explained by referring to FIG. 5 and FIG. 6.

The mail delivery system is utilized in each step of a mail information transmission work shown in FIG. 5, and a mail information reception/delivery work shown in FIG. 6.

At first, the mail information transmission work will be explained by referring to FIG. 5.

In FIG. 5, the user 100 commissions the mail soft at the mail terminal 110 in a step A1, and inputs as the transmission destination mail address information 130 the destinations 131, 132, . . . , 13n, which are composed of the transmission destination mail addresses 131a, 132a, . . . , 13na, and the destination names 131b, 132b, . . . , 13nb, in a step A2.

Continuously, the user 100 inputs the mail text etc. in a step A3, and prepares the electronic mail information 120 as shown in a step A4.

And, the user 100 clicks, for example, a transmission button of the mail soft, and thereby, the mail terminal 110 is connected to the mail server of the mail delivery center 200 on the transmitting side to transmit the electronic mail information 120 in the step A4.

In response to this, the receiving section 210 of the mail delivery center 200 on the transmitting side receives the electronic mail information 120 to be sent from the mail terminal 110 of the user 100.

And, based on the transmission destination mail addresses 131a, 132a, . . . , 13na to be included in the transmission destination mail address information 130 of this electronic mail information 120, the transmitting section 210 of the mail delivery center 200 on the transmitting side transmits the above electronic mail information 120 to the mail delivery center 300 on the receiving side via the network 500 in a step A5.

In such a manner, the mail information transmission work is completed.

Next, the mail information reception/delivery work will be explained by referring to FIG. 6.

In FIG. 6, the receiving section 310 of the mail delivery center 300 on the receiving side receives the electronic mail information 120 to be sent from the transmitting section 210 of the mail delivery center 200 on the transmitting side via the network 500 in a step B1.

And, for each of the transmission destination mail addresses 131a, 132a, . . . , 13na in the so-called ┌To┘ field out of the transmission destination mail address information 130 of the above electronic mail information 120, the receiving section 310 of the mail delivery center 300 on the receiving side reads out the register keyword 321, which corresponded to the above mail address, from the storage section 320 in a step B2.

Continuously, the receiving section 310 of the mail delivery center 300 on the receiving side makes reference to this register keyword 321, retrieves the keyword from each of destination names 131b, 132b, . . . , 13nb, and makes the collation of the keyword in a step B3.

Additionally, as to the collation of the keyword, even though the register keyword 321 and each of the destination names 131b, 132b, . . . , 13nb do not accord, if the keyword is included in each of the destination names 131b, 132b, . . . , 13nb, it is acceptable.

Herein, when the collation of the keyword was able to be made in the step B3, the receiving section 310 of the mail delivery center 300 on the receiving side permits the incoming of the above electronic mail information 120 in a step B4, and delivers the above electronic mail information 120 to the transmission destination mail address 131, and the process is finished.

In addition, specifically, the delivery of the electronic mail information 120 is carried out as follows. That is, the above electronic mail information 120 of which the incoming was permitted is related to the transmission destination mail address 131, and is registered to the storage section 320 as the received mail. And, the user 400 who is an owner of the transmission destination mail address makes access to the above mail delivery center 300 on the receiving side by means of its mail terminal 410 to read out the above electronic mail information 120 registered in the storage section 320 of the above mail delivery center 300 on the receiving side, and thereby the delivery is completed.

Also, in the event that the collation of the keyword was not able to be made in the step B3, for each transmission destination mail address (not shown in the figure) in the so-called ┌Cc┘ field out of the transmission destination mail address information 130 of the above electronic mail information 120, the receiving section 310 of the mail delivery center 300 on the receiving side reads out the register keyword 321, which responded to the above mail address, from the register section 320 in a step B5.

Continuously, the receiving section 310 of the mail delivery center 300 on the receiving side makes reference to this register keyword 321, retrieves the keyword from each destination name, and makes the collation of the keyword in a step B6.

Herein, when the collation of the keyword was able to be made in the step B6, the receiving section 310 of the mail delivery center 300 on the receiving side permits the incoming of the above electronic mail information 120, and delivers the above electronic mail information 120 to the transmission destination mail address 131 in the step B4, and the process is finished.

To the contrary, in the event that the collation of the keyword was not able to made in the step B6, for each of the transmission destination mail address (not shown in the figure) in the so-called ┌Bcc┘ field out of the transmission destination mail address information 130 of the above electronic mail information 120, the receiving section 310 of the mail delivery center 300 on the receiving side reads out the register keyword 321 that responded to the above mail address from the register section 320 in a step B7.

Continuously, the receiving section 310 of the mail delivery center 300 on the receiving side makes reference to this register keyword 321, retrieves the keyword from each destination name, and makes the collation of the keyword in a step B8.

Herein, when the collation of the keyword was able to be made in the step B8, the receiving section 310 of the mail delivery center 300 on the receiving side permits the incoming of the above electronic mail information 120, and delivers the above electronic mail information 120 to the transmission destination mail address 131 in the step B4, and the process is finished.

To the contrary, in the event that the collation of the keyword was not able to be made in the step B8, the receiving section 310 of the mail delivery center 300 on the receiving side rejects the incoming of the above electronic mail information 120 in a step B9, and transmits the error to the mail delivery center 200 on the transmitting side of the above electronic mail information 120 in a step B10.

Thereafter, the receiving section 310 of the mail delivery center 300 on the receiving side cancels the above electronic mail information 120 in a step B11, and the process is completed.

In such a manner, the mail information reception/delivery work is completed.

As explained above, in accordance with this embodiment, the user 400 on the receiving side pre-informs the user 100 on the transmitting side of the keyword 321, and thereby, the user 100 on the transmitting side inputs the above-mentioned keyword 321 into any one of the destination names of the so-called ┌To┘ field, ┌Cc┘ field, and ┌Bcc┘ field out of the transmission destination mail address 130 of the electronic mail information 120, prepares the electronic mail information 120, and transmits it to the mail address of the user 400.

Thereby, when the receiving section 330 of the mail delivery center 300 on the receiving side received the electronic mail information 120 addressed to the mail address of the user 400, it makes the collation of the register keyword 321, which was related to the transmission destination mail address of the above electronic mail information 120 and was pre-registered, from any one of the destination names of the so-called ┌To┘ field, ┌Cc┘ field, and ┌Bcc┘ field out of the transmission destination mail address information 130 of the above electronic mail information 120.

And, only when the keyword collation was able to be made, the receiving section 330 of the mail delivery center 300 on the receiving side permits the incoming of the above electronic mail information 120, and transmits it to the transmission destination mail address.

To the contrary, when the keyword collation was not able to be made, the receiving section 330 of the mail delivery center 300 on the receiving side rejects the incoming of the above electronic mail information 120.

In such a manner, the user 400 can reject the incoming of the electronic mail having no pre-registered keyword included in the destination name of the transmission destination mail address information 130.

The foregoing embodiment was configured so that the user 100 transmitted the electronic mail information 120 to the user 400 through the mail delivery center 300 on the receiving side from the mail delivery center 200 on the transmitting side via the network 500; however the embodiment is not limited to this, also in the event that the user 400 transmits the electronic mail information to the user 100, the process is performed similarly, furthermore, also in the event that user 100 transmits the electronic mail information to the user who belongs to the ISP having the same mail delivery center 200 provided, similarly, the receiving section 230 of the mail delivery center 200 on the receiving side at this moment makes the keyword collation of the electronic mail information 120 in a similar manner, and thereby, can carry out the incoming rejection of the electronic mail information for which the keyword collation was not able to be made.

Also, in the foregoing embodiment, the transmission destination mail address information 130 of the electronic mail information 120 includes n pairs of the destinations 131 to 13n; however it is not limited to this, and apparently, it is acceptable that at least one pair of the destinations is included.

Furthermore, in the foregoing embodiment, the network 500 is configured as the so-called internet; however it is not limited this, and apparently it is acceptable that it is, for example, an in-house network such as an office LAN.

Also, the foregoing embodiment is configured so that each of the users 100 and 400 make access to the mail delivery centers 200 and 300 via the access point that the ISP, to which each user belongs, provides; however it is not limited to this, and apparently it is acceptable that the network connection is made to the mail delivery centers 200 and 300.

Additionally, the process in an information management apparatus of the mail delivery center in the embodiment to be described below is executed with a program-controlled computer. As a record medium, for example, can be used a magnetic disc, a semiconductor memory, and the medium that can be read out by the other optional computers. Also, the program recorded in the record medium may be loaded into, by directly mounting the record medium on the computer, the above computer, and also may be loaded into the computer via the telecommunication circuit.

As mentioned above, in accordance with the present invention, when the electronic mail transmitted to the mail delivery center on the receiving side from the transmitting section of the mail delivery center on the transmitting side via the network is received in the receiving section of the mail delivery center on the receiving side, the received electronic mail is keyword-collated from the destination name of its transmission destination mail address information in the receiving section of the mail delivery center on the receiving side, and only the electronic mail for which the keyword collation was able to be made is transmitted to the above transmission destination mail address. To the contrary, the incoming of the electronic mail for which the keyword collation was not able to be made is rejected, and the above electronic mail is not transmitted.

Accordingly, the user pre-informs of the keyword the partners having the possibility of transmitting the mail, and thereby can receive only the normal electronic mail having the keyword input into the destination name, and reject the incoming of the unnecessary electronic mail such as the junk mail.

Also, utilization of the destination name, which can not be generally grasped in the event of automatically generating the mail address in the junk mail etc. and the like, as the keyword allows the incoming of the unnecessary electronic mail such as the junk mail to be rejected certainly, by taking a real name, a popular name, a nickname etc. as the keyword even though a special password is not used as the keyword.

What is claimed is:

1 In a mail delivery system including a plurality of mail delivery centers connected to each other via a network wherein electronic mail that is composed of transmission destination mail address information and a mail text etc. from a user's mail terminal is transmitted from the mail delivery center on an transmitting side to the mail delivery center on a receiving side, which corresponds to a transmission destination mail address, via the network, a mail-incoming rejection system characterized in that:
the above-mentioned transmission destination mail address information of the electronic mail has a transmission destination mail address, and a destination name, said destination name having a keyword specific to the transmission destination mail address included; and
each mail delivery center comprises:
a transmitting section for transmitting the electronic mail received from each user's mail terminal to the other mail delivery center, which corresponds to the transmission destination mail address, via the network, or transmitting it to a receiving section of the above mail delivery center; and
a receiving section for, with regard to the electronic mail received from the other mail delivery center via the network, or transmitted from the transmitting section, collating the keyword from the destination name to be included in the transmission destination mail address information to deliver only the electronic mail, for which collation of the keyword was able to be made, to the above transmission destination mail address, and not to deliver the electronic mail for which the collation of the keyword is not able to be made.

2 The mail-incoming rejection system according to claim 1, whereon said receiving section of each mail delivery center comprises a storage section for, with regard to a mail address of a user that belongs hereto, registering a data base that is composed of pre-established keywords.

3 The mail-incoming rejection system according to claim 1, wherein said receiving section cancels the electronic mail when said receiving section was not able to make the collation of the keyword.

4 The mail-incoming rejection system according to claim 1, wherein when said receiving section was not able to make the collation of the keyword, with regard to the above electronic mail, said receiving section replies an error for the mail delivery center on the transmitting side.

5 The mail-incoming rejection system according to claim 1, said mail-incoming rejection system characterized in that:
the above-mentioned transmission destination mail address information has a plurality of transmission destination mail addresses and destination names; and
the above-mentioned keyword is included in any one of the destination names.

6 In a mail delivery system including a plurality of mail delivery centers connected to each other via a network wherein electronic mail that is composed of transmission destination mail address information and a mail text etc. from a user's mail terminal is transmitted from the mail delivery center on an transmitting side to the mail delivery center on a receiving side, which corresponds to a transmission destination mail address, via the network, a mail-incoming rejection method comprising:
a first step of, at the time of preparing the electronic mail, with regarding to transmission destination mail address information that is composed of a transmission destination mail address and a destination name, inputting a keyword specific to the transmission destination mail address into its destination name;
a second step of collating the keyword from the destination name to be included in the transmission destination mail address information in the mail delivery center on the receiving side that received delivery of the above electronic mail; and
a third step of delivering only the electronic mail, for which collation of the keyword was able to made, to the above transmission destination mail address, and not delivering the electronic mail for which the collation of the keyword is not able to be made.

7 The mail-incoming rejection method according to claim 6, said mail-incoming rejection method characterized in that, in said third step, with regard to the mail address of a user that belongs, reference is made to a data base that is composed of pre-established keywords to make the collation of the keyword.

8 The mail-incoming rejection method according to claim 6, said mail-incoming rejection method characterized in that, in said third step, when the collation of the keyword was not able to be made, the above electronic mail is canceled.

9 The mail-incoming rejection method according to claim 6, said mail-incoming rejection method characterized in that, in said third step, when the collation of the keyword was not able to be made, with regard to the above electronic mail, an error is replied for the mail delivery center on the transmitting side.

10 The mail-incoming rejection method according to claim 6, said mail-incoming rejection method characterized in that, in said first step, with regard to the transmission destination mail address information having a plurality of the transmission destination mail addresses and the destination names, the keyword is input into any one of the destination names.

11 A mail-incoming rejection program for causing a computer to execute a process of receiving electronic mail, which is composed of transmission destination mail address information and a mail text etc. from a user's mail terminal, in a mail delivery center on a receiving side that corresponds to a transmission destination mail address, and delivering only the normal electronic mail to the transmission destination mail address, said mail-incoming rejection program characterized in that: the electronic mail addressed to a mail address of a user that belongs is received;
a keyword is collated from a destination name to be included in the transmission destination mail address information of the above electronic mail; and
only the normal electronic mail for which collation of the keyword was able to be made is delivered to the above transmission destination mail address, and the unjust electronic mail for which the collation of the keyword is not able to made is not delivered.

12 A computer for executing a process of receiving electronic mail, which is composed of transmission destination mail address information and a mail text etc. from a user's mail terminal, in a mail delivery center on a receiving side that corresponds to a transmission destination mail address, and delivering only the normal electronic mail to the transmission destination mail address, said computer executing a process of:
receiving the electronic mail addressed to a mail address of a user that belongs;
collating a keyword based on a destination name to be included in the transmission destination mail address information of said electronic mail; and
delivering the normal electronic mail for which collation of the keyword was able to be made to said transmission destination mail address and un-delivering the unjust electronic mail for which the collation of the keyword is not able to made.
